(19) United States
(12) Patent Application Publication
(10) Pub. No.: US 2010/0222101 A1
(43) Pub. Date: Sep. 2, 2010

(54) TERMINAL CONVERSION ADAPTOR AND MOBILE APPARATUS

(75) Inventors: Ippo AOKI, Tokyo (JP); Akira ISHIKURA, Kawasaki-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/545,195

(22) Filed: Aug. 21, 2009

(30) Foreign Application Priority Data
Feb. 27, 2009 (JP) P2009-046655

(51) Int. Cl. H04M 1/00

(52) U.S. Cl. 455/557

(57) ABSTRACT

A terminal conversion adaptor includes: a plug unit configured to be inserted into a connector provided in a mobile apparatus, the connector having a plurality of terminals; and a terminal unit having a terminal exposed outward, the terminal configured to electrically connect to at least one of the plurality of terminals when the terminal unit is attached to the mobile apparatus.

### CROSS-REFERENCE TO RELATED APPLICATIONS

The entire disclosure of Japanese Patent Application No. 2009-046655 filed on Feb. 27, 2009, including specification, claims, drawings and abstract is incorporated herein by reference in its entirety.

### BACKGROUND

1. Field of the Invention

One aspect of the present invention relates to an adaptor for converting a terminal into a different kind of terminal, and a mobile apparatus provided with the adaptor.

2. Description of the Related Art

Recently, mobile apparatuses are provided with connectors (jack) based on Association of Radio Industries and Businesses (ARIB) standard or Universal Serial Bus (USB) standard (see JP-A-2005-6497, for instance).

The connectors in the mobile apparatuses are provided with various terminals for data communication, power supply, and the like. Connectors (plugs) of connection cables or charge cables inserted into the connectors in the mobile apparatuses are also provided with various terminals for data communication, power supply, and the like. In the mobile apparatus, the connector terminal in the corresponding mobile apparatus is connected to the connector terminal of the cable, thereby connected to an external device such as a personal computer and supplied electric power to a battery.

As a conceivable example of an operation where a user inserts a plug into a jack in a mobile apparatus, a user sees that an inserting direction of the plug coincides with a direction of the jack, and then the user carries out an inserting operation. Or when the user tries to insert the plug into the jack, first, the user inserts the plug into the jack without considering the inserting direction, then the plug cannot be structurally inserted into the jack, the user performs the inserting operation again by changing the direction of the plug.

The jack in the mobile apparatus has a very small insertion port according to the small size of the mobile apparatus. For example, recently, a very small USB jack such as a micro USB based on the USB standard has been known.

As the jack becomes smaller, it is expected that the operation of inserting the plug into the jack in the mobile apparatus will become more difficult. Those who have difficulty in visually seeing the mobile phone, particularly, people with weak eyesight or who are longsighted have also difficulty in finding a position of the jack in the mobile phone or opening a cap covering the jack before the inserting operation of the plug.

In order to solve the problem, it is conceivable to provide a mobile apparatus with plate-shaped terminals made of metal or the like instead of the jack provided in a mobile phone. The mobile apparatus provided with the plate-shaped terminals is used while mounted on a base having spring-shaped terminals able to be electrically connected to the plate-shaped terminals. The mobile apparatus is configured to perform connection to external devices, power supply, or the like through the base. Accordingly, it is possible to easily perform the connection operation as compared with the case of the connection between the jack and the plug.

However, to perform the connection, the base is always necessary. When the user does not have the base, the connection cannot be performed, which may not be preferable.

The mobile apparatus may have a configuration for providing plural terminals for connection to the base or for providing both the jack and the terminals for connection to the base. However, when the mobile apparatus is provided with an area for the terminals and the number of components is increased, the size of the mobile apparatus increases.

### SUMMARY

According to an aspect of the invention, there is provided a terminal conversion adaptor including a plug unit configured to be inserted into a connector provided in a mobile apparatus, the connector having a plurality of terminals; and a terminal unit having a terminal exposed outward, the terminal configured to electrically connect to at least one of the plurality of terminals when the terminal unit is attached to the mobile apparatus.

### BRIEF DESCRIPTION OF THE DRAWINGS

Embodiment may be described in detail with reference to the accompanying drawings, in which:

FIG. 1 is an exemplary perspective view illustrating a mobile apparatus of an embodiment of the invention;

FIG. 2 is an exemplary side view illustrating the mobile apparatus according to the embodiment of the invention;

FIGS. 3A to 3F are exemplary views, each illustrating a terminal conversion adaptor according to the embodiment of the invention;

FIG. 4 is an exemplary perspective view illustrating the appearance of a base for mounting the mobile apparatus according to the embodiment;

FIG. 5 is an exemplary view illustrating the appearance when the mobile apparatus according to the embodiment is mounted on the base;

FIG. 6 is an exemplary cross-sectional view illustrating the base taken along the line VI-VI shown in FIG. 5;

FIG. 7 is an exemplary partially enlarged view illustrating a part VII of the base shown in FIG. 6;

### DETAILED DESCRIPTION OF THE EMBODIMENTS

A mobile apparatus and a terminal conversion adaptor according to an embodiment of the invention will be described with reference to the accompanying drawings. As an example of a mobile apparatus according to the invention, there is a mobile apparatus that can be operated by a user touching a display with a finger.

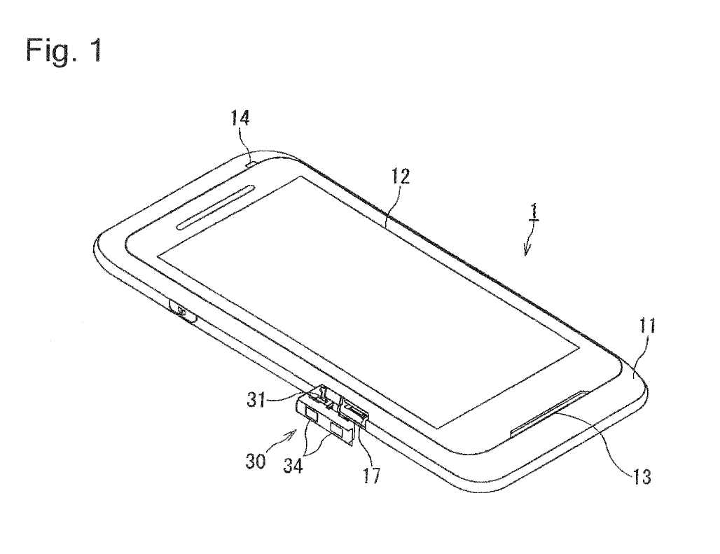

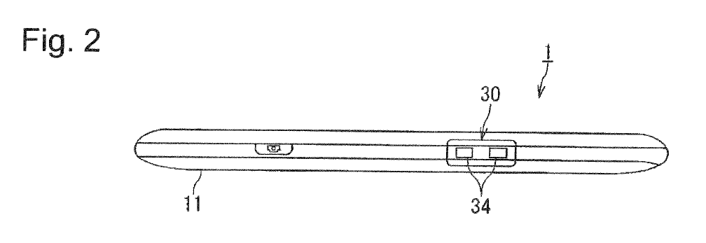

FIG. 1 is a perspective view illustrating the mobile apparatus according to the embodiment of the invention FIG. 2 is a side view illustrating the mobile apparatus according to the embodiment of the invention.

As shown in FIG. 1, the mobile apparatus 1 is provided with a rectangular plate-shaped casing 11. A touch screen 12 occupying most of one surface of the casing 11 is provided on the surface.

The touch screen 12 has both functions, that is, a function of a display provided with an area for displaying a picture formed of texts and images and a function of operation keys provided with a touch sensor for receiving inputs by sensing a contact operation on the display. The touch screen 12 is provided with a display formed of, for example, a Liquid Crystal Display (LCD). On an upper face of the display, plural elements for sensing contact on the surface of the display, and a transparent screen is formed thereon. A pressure sensitive method of sensing change in pressure, an electrostatic method of sensing electrical signals by static electricity, and the other methods can be applied to a method of sensing the contact onto the touch screen 12.

The case 11 is provided with a speaker 13 for outputting sound and a microphone 14 for inputting sound. The mobile apparatus 1 is provided with an external connection terminal 17 on a side thereof. The external connection terminal 17 is for connection to external devices and a charger. The external connection terminal 17 (jack) is a jack-type terminal. The external connection terminal 17 is a terminal connected to a connector (not shown) such as a charging cable used to supply electric power to a battery and a USB cable used to connect the mobile apparatus 1 to various external devices such as a personal computer.

The external connection terminal 17 is, for example, a micro B terminal of a micro USB terminal, an “ARIB-A” connector, or the like. The external connection terminal 17 has a plurality of various terminals. A micro USB receptacle provided with power terminals (VBUS and GND) for charging the battery of the mobile apparatus 1, a data signal terminal (D plus terminal, D minus terminal, etc.), an ID terminal, and the like is applied to the external connection terminal 17 in the embodiment.

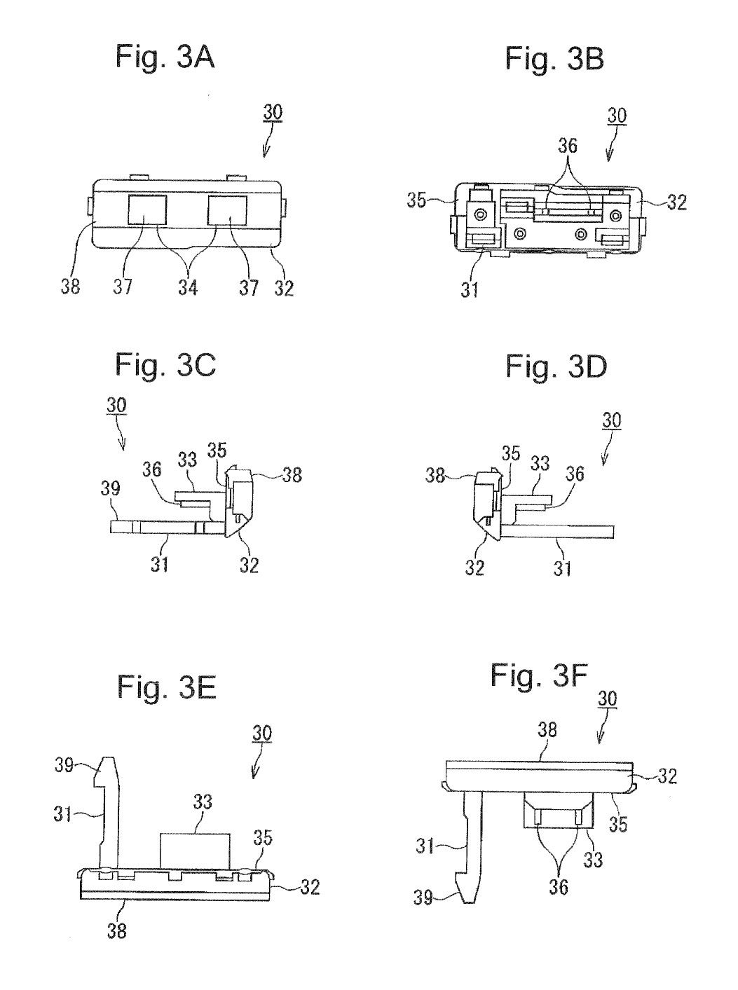

A terminal conversion adaptor 30 is attached to the external connection terminal 17. The terminal conversion adaptor 30 is connected to the casing 11 via a connection portion 31. As shown in FIG. 2, the connection portion 31 is housed in the casing 11, and the terminal conversion adaptor 30 is attached to the external connection terminal 17 integrally and flattly on the side face of the casing 11. As shown in FIG. 1, when the terminal conversion adaptor 30 is detached from the external connection terminal 17, the terminal conversion adaptor 30 extends by a predetermined length with a locking portion (locking portion 39 in FIGS. 3C, 3E and 3F) of the connection portion 31 locked to the casing 11. Accordingly, the connector is able to be inserted into the external connection terminal 17.

FIGS. 3A to 3F are views illustrating the terminal conversion adaptor according to the embodiment of the invention.

FIG. 3A is a front view of the terminal conversion adaptor 30, and FIG. 3B is a rear view of the terminal conversion adaptor 30 shown in FIG. 3A. FIG. 3C is a left side view of the terminal conversion adaptor 30 shown in FIG. 3A, and FIG. 3D is a right side view thereof. FIG. 3E is a top view of the terminal conversion adaptor 30 shown in FIG. 3A, and FIG. 3F is a bottom view thereof.

The terminal conversion adaptor 30 includes an adaptor body 32, a plug unit 33, and a terminal unit 34.

The adaptor body 32 covers the external connection terminal 17 provided in the casing 11 of the mobile apparatus 1. The adaptor body 32 is attached to the external connection terminal 17 integrally and flattly on the side face of the casing 11 (see FIG. 2).

The plug unit 33 protrudes from a plug face 35 in contact with the casing 11 of the mobile apparatus 1, the plug face 35 is one face of the adaptor body 32. The plug unit 33 is inserted into the external connection terminal 17 in the mobile apparatus 1.

In the plug unit 33, apparatus-side connection terminals 36 and 36 of the terminal unit 34 are exposed. The apparatus-side connection terminals 36 and 36 in the plug unit 33 are configured to be electrically connected to at least one of the terminals of the external connection terminal 17. The plug unit 33 according to the embodiment is described as a micro USB plug provided with two power terminals (VBUS and GND) as the apparatus-side connection terminals 36 and 36 corresponding to the power terminals of the external connection terminal 17. That is, the terminal conversion adaptor 30 is described as an adaptor provided with terminals to which electric power is supplied.

The terminal unit 34 converts the external connection terminal 17 in the mobile apparatus 1 into flat terminals (plate-shaped terminals) 37 and 37. The flat terminals 37 and 37 are exposed from a flat terminal face 38 that is the face opposite to the face on which the plug unit 33 in the adaptor body 32 is provided. The terminal unit 34 is made of, for example, a conductive metal member. The flat terminals 37 and 37 in the terminal conversion adaptor 30 serve as a connector for connection to terminals of a base when the mobile apparatus 1 is mounted on the base.

The connection portion 31 protrudes on the plug face 35 in the adaptor body 32. The locking portion 39 is provided at a leading end of the connection portion 31. When the terminal conversion adaptor 30 is detached, the locking portion 39 is locked to the casing 11, thereby maintaining the connection of the terminal conversion adaptor 30 to the casing 11.

The terminal conversion adaptor 30 may be made of, for example, a material having elasticity such as elastomer, or plastic. The terminal unit 34 may be formed by having metal plating on stainless steel. The terminal conversion adaptor 30 may be integrally formed from these materials by insert molding.

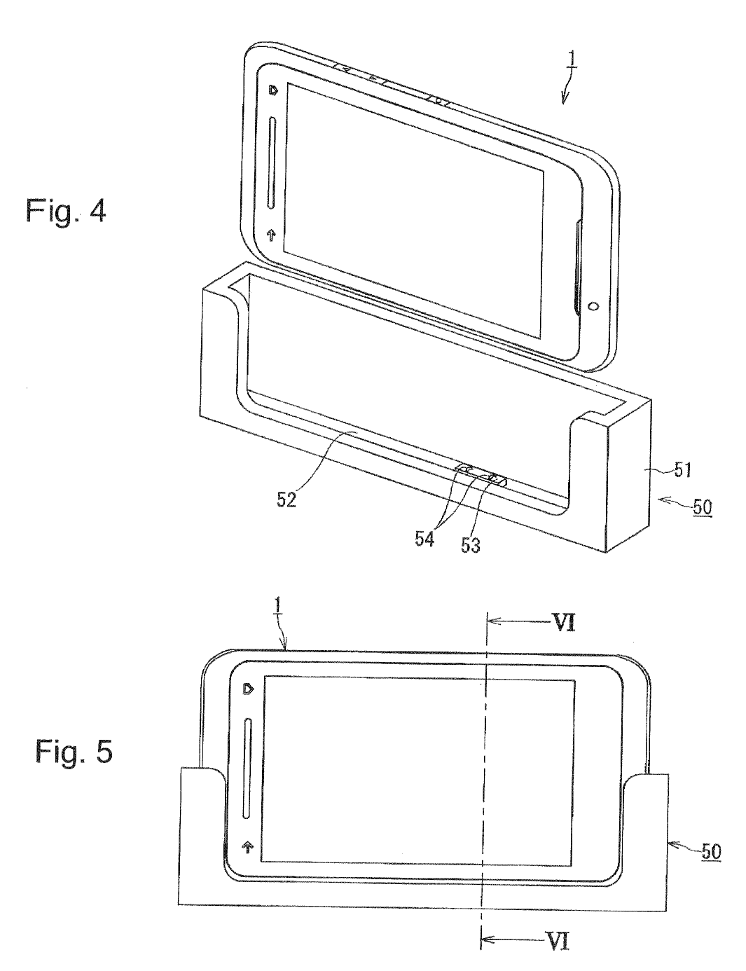

FIG. 4 is a perspective view illustrating appearance of a base on which the mobile apparatus 1 according to the embodiment is mounted.

The base 50 includes a guide portion 51, a base portion 52, and a spring terminal portion 53.

The guide portion 51 serves as a guide for indicating a position and a direction of mounting the mobile apparatus 1.

The base portion 52 is apart on which the mobile apparatus 1 is mounted with a side provided with the external connection terminal 17 downward. The base portion 52 is provided with the spring terminal portion 53 at a position corresponding to the terminal conversion adaptor 30 when the mobile apparatus 1 with the terminal conversion adaptor 30 is mounted thereon.

The spring terminal portion 53 has a convex shape toward the mobile apparatus 1 (up direction). In the spring terminal portion 53, spring terminals 54 and 54 protrude toward the mobile apparatus 1.

The spring terminals 54 and 54 are disposed at positions coming into contact with the flat terminals 37 and 37 in the terminal conversion adaptor 30. The spring terminals 54 and 54 are spring-shaped connection terminals, and are pushed back toward the inside of the spring terminal portion 53 at the time of contact with the flat terminals 37 and 37.

The spring terminals 54 and 54 are connected to terminals (not shown) in the external device connector provided in the base 50. The external device connector is a connector for connection to external devices such as a personal computer by a USB cable (not shown), or connection to a charger by a charging cable.

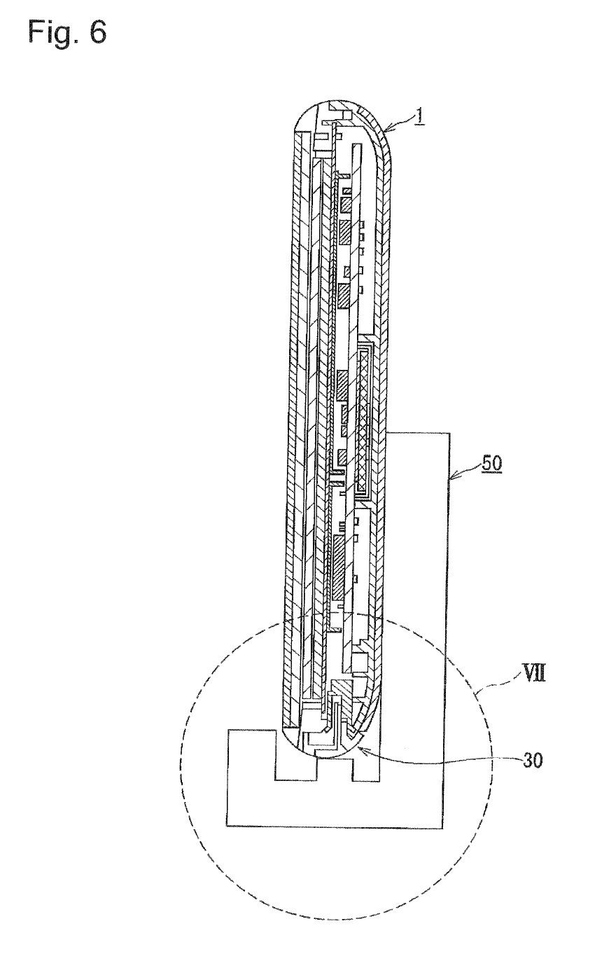

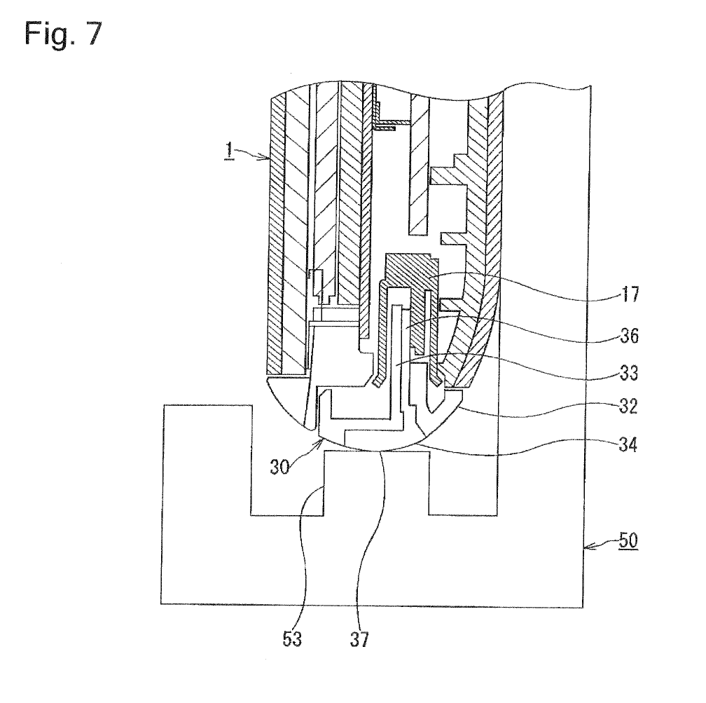

FIG. 5 is a view illustrating appearance when the mobile apparatus 1 according to the embodiment is mounted on the base 50. FIG. 6 is a cross-sectional view of the base 50 taken along the line VI-VI shown in FIG. 5. FIG. 7 is a partially enlarged view of a part VII of the base 50 shown in FIG. 6.

When the terminal conversion adaptor 30 is attached to the mobile apparatus 1, the apparatus-side connection terminals 36 and 36 in the plug unit 33 in the terminal unit 34 are electrically connected to the corresponding power supply terminals in the external connection terminal 17. When the mobile apparatus 1 is mounted on the base 50 along the guide portion 51, the flat terminals 37 and 37 in the terminal conversion adaptor 30 are electrically connected to the spring terminals 54 and 54.

The mobile apparatus 1 is connected to a charger or a personal computer (not shown) connected to the external device connector in the base 50 through the terminal unit 34 of the terminal conversion adaptor 30 and the base 50. Accordingly, charging power is supplied from the charger or the personal computer to the mobile apparatus 1.

According to the terminal conversion adaptor 30 and the mobile apparatus 1 provided with the terminal conversion adaptor 30, it is possible to convert the external connection terminal 17 in the mobile apparatus 1 into the flat terminals 37 and 37. For this reason, it is possible to reduce the number of operations when connecting the plug, and thus it is possible to simply perform the connection between the mobile apparatus 1 and the external device.

The terminal conversion adaptor 30 is integrally and flatly attached with respect to the side face of the casing 11 provided with the external connection terminal 17, and thus the terminal conversion adaptor 30 can serve as a cap on the external connection terminal 17.

When there is no base 50 for connection to the external device using the terminal conversion adaptor 30 as the connection terminal, the connection using the terminal conversion adaptor 30 cannot be performed. In this case, the terminal conversion adaptor 30 is detached from the casing 11 and a cable connectable to the external connection terminal 17 is used, there by enabling direct connecting to the external device.

For people with weak eyesight or who are longsighted, it is conceivable that it is difficult to insert the plug (connector) of the cable into the external connection terminal 17. In this case, the terminal conversion adaptor 30 is attached to the external connection terminal 17, and thus it is possible to easily perform the connection to the external device or the supply of the charging power through the base 50. Accordingly, it is possible to improve accessibility.

In the embodiment, the terminal conversion adaptor 30 provided with the charging terminals has been described, but may be provided with other terminals such as data signal terminals (D plus terminal, D minus terminal, etc.), in addition to the charging terminals.

The terminal conversion adaptor 30 connected to the casing 11 through the connection portion 31 has been described, but the terminal conversion adaptor 30 may have a detachable independent structure without connection to the casing 11.

When the mobile apparatus 1 is not connected to the external device, a cap for covering the external connection terminal 17 may be attached. When the mobile apparatus is connected to the external device, the cap may be detached and the terminal conversion adaptor 30 may be attached. The “cap” is different from the terminal conversion adaptor 30, and is a member which is not provided with the terminals, formed of elastomer or the like.

What is claimed is:

1. A terminal conversion adaptor comprising:
a plug unit configured to be inserted into a connector provided in a mobile apparatus the connector having a plurality of terminals; and
a terminal Unit having a terminal exposed outward, the terminal configured to electrically connect to at least one of the plurality of terminals when the terminal unit is attached to the mobile apparatus.

2. A terminal conversion adaptor comprising:
an adaptor body configured to cover a connector provided in a casing of a mobile apparatus, the connector having a plurality of terminals, the adaptor body having a first face and a second face opposite to the first face;
a plug unit that protrudes from the first face and configured to be inserted into the connector; and
a terminal unit having a terminal exposed outward from the second face, the terminal unit configured to electrically connect to at least one of the plurality of terminals in the connector when the terminal unit is attached to the mobile apparatus.

3. A mobile apparatus comprising:
a casing;
a connector having a plurality of terminals provided in the casing; and
a terminal conversion adaptor having a terminal exposed outside the casing, the terminal conversion adaptor configured to electrically connect to at least one of the plurality of terminals in the connector when the terminal conversion adaptor is attached to the connector.

4. The mobile apparatus of claim 3, wherein the terminal conversion adaptor includes:
an adaptor body configured to cover the connector, the adaptor body having a first face and a second face opposite to the first face;
a plug unit that protrudes from the first face and configured to be inserted into the connector; and
a terminal unit having a terminal exposed outside the casing from the second face, the terminal unit configured to electrically connect to at least one of the plurality of terminals in the connector when the terminal unit is attached to the connector.

5. The mobile apparatus of claim 3, wherein the terminal conversion adaptor further includes a connection portion connected to the casing.

6. The mobile apparatus of claim 4, wherein the terminal conversion adaptor further includes a connection portion connected to the casing.

7. The terminal conversion adaptor of claim 1, wherein the terminal exposed outward has a plate shape.

8. The terminal conversion adaptor of claim 2, wherein the terminal exposed outward has a plate shape.

9. The mobile apparatus of claim 3, wherein the terminal exposed outside the casing has a plate shape.

10. The terminal conversion adaptor of claim 1, further comprising a connection portion connectable to the mobile apparatus.

11. The terminal conversion adaptor of claim 2, further comprising a connection portion connectable to the casing of the mobile apparatus.

12. The terminal conversion adaptor of claim 11, wherein the connection portion protrudes on the first face.

13. The mobile apparatus of claim 3, wherein the terminal conversion adaptor further has a connection portion connectable to the casing.

14. The terminal conversion adaptor of claim 1, wherein the connection portion has a locking portion configured to be locked to the mobile apparatus so that the locking portion maintains connection between the terminal conversion adaptor and the mobile apparatus when the terminal conversion adaptor is detached from the mobile apparatus.

15. The terminal conversion adaptor of claim 2, wherein the connection portion has a locking portion configured to be locked to the casing so that the locking portion maintains connection between the terminal conversion adaptor and the casing when the terminal conversion adaptor is detached from the casing.

16. The mobile apparatus of claim 3, wherein the connection portion has a locking portion configured to be locked to the casing so that the locking portion maintains connection between the terminal conversion adaptor and the casing when the terminal conversion adaptor is detached from the casing.
